(19) United States
(12) Patent Application Publication
(10) Pub. No.: US 2009/0013405 A1
(43) Pub. Date: Jan. 8, 2009

(54) Heuristic detection of malicious code

(75) Inventor: Maksym Schipka, Gloucester (GB)

Correspondence Address: NIXON & VANDERHYE, PC, 901 NORTH GLEBE ROAD, 11TH FLOOR, ARLINGTON, VA, 22203, US

(73) Assignee: MessageLabs Limited, Gloucester (GB)

(21) Appl. No.: 11/822,534

(22) Filed: Jul. 6, 2007

(51) Int. Cl. G06F 11/30

(52) U.S. Cl. 726/22

(57) ABSTRACT

Scanning of computer files for malware uses a classifying technique to classify an input file as a clean file or a dirty file. The parameters of the classifying technique are derived to train the classification on a corpus of reference files including clean files known to be free of malware and dirty files known to contain malware. The classification is performed using a representation of the files in a feature space defined by a set of predetermined features for respective file formats, the features being a predetermined value or range of values for one or more data fields of given meanings. The representation of a file is derived by determining the file format, parsing the file on the basis of the structure of data fields in the determined file format to identify the data fields and their meaning, and determining, on the basis of the identified data fields, which of the set of predetermined features are present.

### BACKGROUND OF THE INVENTION

(1) Field of the Invention

The present invention relates to the scanning of computer files to detect malicious code. The present invention is particularly concerned with malicious code which is unknown to the scanning system or organisation doing the scanning.

(2) Description of Related Art

Malicious code (which will be referred to herein as malware) is a serious problem in the field of computing. Such malware is any code which is not desired by the user, including viruses, Trojans, worms spyware, adware, etc.

The numbers of different pieces of malware is increasing rapidly, with the malware-writing world becoming more retail-oriented and providing for sale pieces of malware for wide ranges of applications and uses. Serious efforts are made to avoid detection by major antivirus engines and it has become easier to create a new piece of malware which can avoid detection by signature-based techniques. There are many different ways to create such new malware automatically, including repackaging malware, changing tiny parts of the file to break the existing signature within an antivirus engine, re-encrypting malware offline with a different encryption key, etc. The consequences of these trends are as follows.

As the number of pieces of malware increase, conventional malware signature databases are becoming very large in size, and therefore in practical terms are more difficult to deploy on any infrastructure. It is also becomes more time-consuming and therefore expensive to maintain and update the database of signatures.

Also, as the individual pieces of malware become less generic and widespread, a given piece of malware may remain undetected for an increasing length of time, because no signature will be created until the given piece of malware is identified to the organisations which create the signatures.

Conventionally, there are two ways of addressing the above problems, as follows.

The first way is to use a generic signatures. This means that there is one signature written for a family or group of pieces of malware. The advantage of this approach is to greatly reduce the number of signature records in databases, while still being easy to manage. However it is difficult to generate such generic signatures and they remain specific to the family of malware to which they relate. Thus generic signatures do not benefit an anti-malware engine in detecting other types of malware, in particular, in the detection of new and unknown threats.

The second way of addressing the above problems is to use heuristic rules. This means that there is a rule manually created that a specialist perceives to be capable of a differentiating between clean and malicious files. The advantage of heuristic rule is that they are not limited to a family of malware and improve the general detection rates of the antivirus engine. A major disadvantage of using heuristic rules is that the rules themselves are difficult to manage and apply. For example, it is difficult to define the scope of the rule and exclusions from the rule. By there nature, heuristic rules more prone to false positives than signature-based techniques.

Many heuristic detection techniques are known and used. Such heuristic techniques attempt to recognise malware by detecting behaviour or features likely to be caused by malware. For example heuristic detection techniques may involve operation of a file in sandbox environment to determine its behaviour or may involve decompilation and examination of the source code. By their nature such heuristic techniques are probabilistic not deterministic. Their development requires consideration of not only the features of the file that make it malicious, but also the potentially limitless number of combinations of those features and the implications upon legitimate files. This is a highly manual, time-consuming process that needs to be performed by highly trained specialists. Generally the heuristic techniques need to be continually developed as the malware is developed to stay ahead of the detection techniques.

Where it is possible to predict how malware will evolve, then in principle effective forms of heuristic detection of the malware can be developed. However, such detection is in practice a very difficult task, both because of the complexity of the malware and the files in which it is found and because of the need to second-guess how the malware will be developed.

There has been some academic research suggesting detection of malicious executable files using a classification technique such as Bayesian filtering trained on a corpus of reference files including clean files known to be free of malware and dirty files known to contain malware. This has generally concentrated on analysis representing the files by features consisting of the underlying binary data, for example by of sequences of plural bytes or features consisting of strings extracted from the executable files for example using an algorithm which searches for sequences of a predetermined number of printable characters terminating in a NUL character.

### BRIEF SUMMARY OF THE INVENTION

According to the present invention, there is provided a method of scanning computer files for malware, the method comprising:

a classification process comprising:

determining the file format of an input file as being one of a plurality of predetermined file formats in accordance with which files comprise data fields having a predetermined structure and predetermined meanings,

determining a representation of the input file in a feature space defined by a set of predetermined features for each file format, the features being a predetermined value or range of values for one or more data fields of given meanings, by parsing the input file on the basis of the structure of data fields in the determined file format to identify the data fields of the input file and their meaning and determining, on the basis of the identified data fields, which of the set of predetermined features are present in the input file as said representation, and

classifying the input file, on the basis of the determined representation of the input file in said feature space, as being a clean file free of malware or a dirty file containing malware using parameters associated with said set of predetermined features; and

a training process comprising:

maintaining a database containing a corpus of reference files including clean files known to be free of malware and dirty files known to contain malware,

determining the file formats of respective reference files as being one of said plurality of predetermined file formats,

determining representations of the respective reference files in said feature space by parsing the respective reference files on the basis of the structure of data fields in the determined file format to identify the data fields of the input file and their meaning, and determining, on the basis of the identified data fields, which of the set of predetermined features are present in the respective reference files as the respective representations, and

deriving said parameters used in said classifying step of said classification process from the corpus of reference files on the basis of the determined representations of the reference files in said feature space.

Further according to the invention, there is provided a system arranged to perform a similar method.

Thus, in accordance with the present invention, scanning of computer files for malware uses a classifying technique to classify an input file as a clean file or a dirty file. The parameters of the classifying technique are derived from training of the classification on a corpus of reference files including clean files known to be free of malware and dirty files known to contain malware.

The significance of different features of a file, as represented by the parameters associated with the features and used in the classification, is derived automatically by the training of the classification technique using the corpus of clean files and dirty files. Thus the need for manual creation of signatures or heuristic analysis techniques is avoided.

The training has the capability of extracting information from the actual files in the corpus of clean and dirty files. Such training of a classification technique is a powerful and effective way of extracting useful information from the files in the corpus. It may be performed automatically and allows the classification to be based on information that might not be immediately apparent to a developer by manual review of the files in the corpus. Thus the invention provides the capability of distinguishing between clean and dirty files by virtue of the similarity with the files in the corpus. In particular, this allows the detection of new pieces of malware even before there has been time to develop a signature for a given piece of malware and including the case that the piece of malware has not previously been encountered. The effectiveness is dependent on the variety of types of files in the corpus but is not dependent on the skill and knowledge of a specialist developer, as is the case with the generation of heuristic analysis techniques. This provides the capability of providing high detection rates and low false positive rates, as compared to manually derived heuristic analysis techniques.

The effectiveness of the classification is improved by the nature of the set of features chosen to form a feature space to represent the files. In particular, the set of predetermined features are defined for respective file formats, the features being a predetermined value or range of values for one or more data fields of given meanings. Thus the representation of a file may be derived by determining the file format, parsing the file on the basis of the structure of data fields in the determined file format to identify the data fields and their meaning, and determining, on the basis of the identified data fields, which of the set of predetermined features are present. As a feature can be a predetermined value or range of values for one or more data fields of given meanings, the features represent meaningful information about the file in terms of its functionality. Example of possible features are set out below but in general the individual features represent the content of the file in the context of the meaning of the data fields concerned. The fields are therefore useful as a basis for classifying the file.

This contrasts with the use of the underlying binary data such as a feature consisting of a sequence of plural bytes. Sequences of the underlying binary data in isolation have little meaning without the context of their meaning within the structure of the file. Similarly the features of the present invention are also more meaningful than mere strings extracted from the file. The features of the present invention are more meaningful in the context of detecting malware because they can relate to the function of the file. Thus the present invention has the capability of providing more effective classification of clean and dirty files.

According to further aspects of the invention, the classification process and the training process, as well as systems implementing similar processes, may be provided in isolation.

The present invention will now be described in more detail by way of non-limitative example with reference to the accompanying drawings.

### BRIEF DESCRIPTION OF THE DRAWINGS

FIG. 1 is a diagram of a scanning system;

FIG. 2 is a diagram of a classification system of the scanning system;

FIG. 3 is a diagram of a training system of the scanning system; and

FIG. 4 is a diagram illustrating the Portable Executable file format.

### DETAILED DESCRIPTION OF THE INVENTION

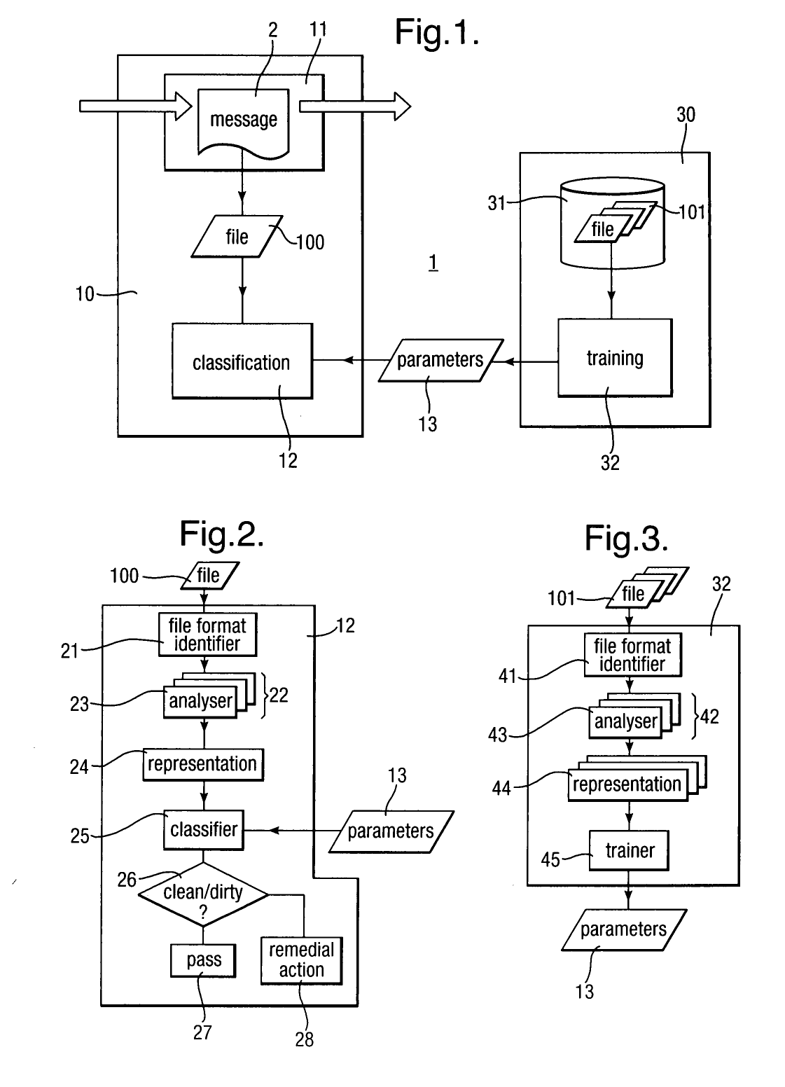

A scanning system 1 for scanning messages 2 passing through a network is shown in FIG. 1. The messages 2 may be emails, for example transmitted using SMTP or may be messages transmitted using other protocols such as FTP, HTTP, IM, SMS, MMS and the like.

The scanning system 1 scans the messages 2 for computer files 100 to detect malicious programs hidden in the files 100. The scanning system 1 is provided at a node of a network and the messages 2 are routed through the scanning system 1 as they are transferred through the node en route from a source to a destination. The scanning system 1 may be part of a larger system which also implements other scanning functions such as scanning for viruses using signature-based detection, heuristic analysis and/or scanning for spam emails.

However, although this application is described for illustrative purposes, the scanning system 1 could equally be applied to any situation where malware might be hidden inside files 100, and where the file 100 can be assembled and presented for scanning. This could include systems such as firewalls, file system scanners and so on.

The scanning system 1 may be implemented in software running on suitable computer apparatuses at the node of the network and so for convenience part of the scanning system 1 will be described with reference to a flow chart which illustrates the process performed by the scanning system 1. In fact various parts of the scanning system 1 may alternatively be implemented in hardware.

The scanning system 1 comprises a classification system 10 and a training system 30. Although the scanning system 10 and the training system 30 may be implemented in the same computer system, in many implementations they will be implemented in different computer systems which may be geographically separated.

The classification system 10 has an object extractor 11 which analyses messages 2 passing through the node to detect and extract any files 100 contained within the messages 2. The object extractor 11 will behave appropriately according to the types of message 2 being passed. In the case of messages 2 which are emails, the object extractor 11 extracts files 100 attached to the emails. In the case of HTTP traffic, the files 100 will typically be web pages, web page components and downloaded files. For FTP traffic, the files 100 are files being uploaded or downloaded. For IM traffic, the files 100 may be either or both of files being transferred via IM, eg as attachments, or may be Rich Text or HTML messages themselves. The message 2 may need processing to extract the underlying file 100. For instance, with both SMTP and HTTP the object may be MIME-encoded, and the MIME format will therefore need parsing to extract the underlying file 100. The extracted files 100 may be stored in a queue until they can be processed.

Thus the file 100 may be a file which manifests itself as a file to the user, for example being stored in a file system of a computer. However the file 100 may also be an intrinsic part of a communication protocol which is rendered without the existence of the file necessarily being evident to the user. An example of this is an IM message in which the message is actually a file in Rich Text or HTML format. Thus in general the scanning system 1 can scan any type of file 100 which is in accordance with a file format.

The classification system 10 further includes a classification subsystem 12 which receives successive files 100 extracted by the object extractor 11 as input files and classifies each file 100 as being a clean file free of malware or a dirty file containing malware. The classification subsystem 12 is described in more detail below but in general terms it implements a classification technique in which file is represented in a feature space defined by a set of features and the classification is based on parameters 13 associated with the features in the set. Those parameters 13 are derived by the training system 30 in order to train the classification technique implemented by the classification subsystem 12.

The training system 30 maintains a database 31 storing a corpus of reference files 101 collected by the developer of the scanning system 1. The reference files 101 are divided into classes including at least one class of clean files 101a known to be free of malware and at least one class of dirty files 101b known to contain malware. The class of each reference file 101 is stored in the database 31 based on the knowledge of the developer of the scanning system 1. The training system 30 includes a training subsystem 30 which is supplied with the reference files 101 and uses them to derive the parameters 13 which are then supplied to the classification system 10.

The effectiveness of the scanning system 1 is dependent on the number and variety of reference files 100. Ideally, the corpus includes reference files 100 of as all different types of file which are likely to be encountered in the wild. In practice the corpus should be continually updated to include new reference files 100, especially examples of new types of clean files and dirty files as they are encountered. The training subsystem 30 is operated periodically to update the parameters as new reference files 100 are added to the corpus.

The scanning system 1 may employ just two classes, ie respectively representing that the file 101 is clean or dirty. Alternatively the scanning system 1 may employ plural classes representing that the file 101 is dirty and/or plural classes representing that the file 101 is clean, each class being associated with a particular type of dirty file or a particular type of clean file on the basis of an assessment by the developer of the scanning system 1. Regardless of the number of classes, the classification subsystem 12 classifies each file 100 as belonging to one of the classes. Classification in any of the dirty/clean classes signifies a classification that the file 100 is dirty/clean. The use of more than two classes can improve the effectiveness of the classification because it allows independent classification for different types of file, although at the expense of greater computational cost.

Next the nature of the feature space used by the classification technique will be considered. The scanning system 1 is applicable to files 100 or 101 having a file format. The input files 100 and the reference files 101 are represented in a feature space defined by a set of predetermined features which are specific to the file format of the file 100 or 101.

A file format is a format for the data within a computer file. The data has a predetermined structure allowing it to be properly read and used, for example by an operating system or an application program. Thus a file format is effectively a contract between the creator of the file and the reader of the file that ensures that the reader of the file can interpret the data stored in a file in order to process the file. The data is arranged in data fields having a predetermined structure in accordance with the file format. The actual structure varies from one file format to another. The individual data fields within that structure each have a certain meaning in accordance with the file format. Such a structure of data fields with specific meanings allows the file 100 or 101 to be interpreted, this indeed being the purpose of a file format.

A large number of file formats are known and in common usage in computer systems. These include file formats for documents allowing the file 100 or 101 to be rendered by an application program and file formats allowing the file 100 or 101 to be processed by an operating system. The scanning system 1 can handle multiple different file formats, ideally all file formats which might be encountered in practice in the type of message 2 being scanned.

For each file format, the scanning system 1 uses a set of predetermined features which include features based on the file format. In particular the features consist of a predetermined value or range of values for one or more of the data fields having given meanings. Further description and examples of the features are given below.

There will now be described in detail the classification subsystem 12 and the training subsystem 32 which are shown in FIGS. 2 and 3, respectively.

The classification subsystem 12 comprises a file format identifier 21 and an analyser section 22 which together extract a representation 24 of the input file 100 in the feature space.

As the features are specific to the file format, initially the input file 100 is supplied to the file format identifier 21 which determines the file format of the file 100. Thus the file format identifier 21 can recognise a multiple different file formats, ideally all file formats which might be encountered in the type of message 2 being scanned.

The file format identifier 21 determines the file format using any reliable technique available. Some examples of such techniques are given below One simple technique is to determine the file format based on the filename extension of the file 100, that is the section of the name of the file 100 following the final period. Different file formats generally have different filename extensions. However, the filename extension might not be always reliable, for example in the circumstances that more than one format uses the same extension or that an instance of a file 100 has an incorrect filename extension.

Another technique is to detect so-called “magic numbers” that are stored inside the file 100 at certain offsets, usually at the beginning of the file 100. Such magic numbers are specific to the file format. Different magic numbers are stored for different file formats and the file 100 is scanned for each stored magic number. For instance, GIF picture objects start with the three characters ‘GIF’. DOS Exe objects start with the two bytes ‘MZ’. OLE objects start with the hex bytes 0xD0 0xCF. In other cases, the magic bytes are not present at the start of the file 100. TAR objects have 257 bytes and then the sequence ‘ustar’. Yet other objects have a sequence of magic bytes, but not at any fixed offset in the file 100. For instance, Adobe PDF objects usually start with the sequence ‘%PDF’, but it is not actually necessary for this sequence to be right at the start of the object. Location of the magic numbers indicates a likelihood that the file 100 is of the respective file type. The magic numbers may be derived from published specifications of the file format or may be derived statistically from examination of actual examples of files of known format.

Once the magic number for a given file format have been found, the file format identifier 21 may, for certain file formats, perform some extra checks using additional known structural features to verify the file 100 really is of the suspected file format.

When the scanning system 1 is part of a larger system such as an SMTP scanner or a HTTP scanner, the file 100 may have an associated type, such as a MIME type. When such information is available, another technique is to use it to determine the file format.

The various techniques may be used in combination, or may be used together to identify different respective file types. For example, the simple technique of using the filename extension may be applied for file formats where the filename extension is known to be unique.

Thereafter the input file 100 is supplied to the analyser section 22 which comprises a plurality of analysers 23. Each analyser 23 is specific to a given file format and analyses the file 100 to detect the set of features which define the feature space in respect of the given file format to which the analyser is specific. Thus there is selected the analyser 23 specific to the file format of the file 100 determined by the file format identifier 21. The file 100 is analysed by the selected analyser 23.

Each analyser 23 analyses a file 100 as follows.

Firstly, the analyser 23 processes the file 100 to parse the file 100. The parsing is performed on the basis of the structure of the file format to which the analyser 23 is specific. With knowledge of the file format the data fields of the file 100 can be identified and their content and structure determined. The analyser 23 has a built-in or external (in an external data file) knowledge about the internal structure of the file format that enables the analyser 23 to identify the data fields of the file 100 and the meaning of those data fields in the context of the file format. The precise techniques used depend on the actual file format. For example, the parsing may use, in any combination: a knowledge of the sequence in which data fields must be present in the file 100; magic bytes identifying the data fields; or offsets in the file 100, or otherwise.

Secondly, the analyser 23 determines which of the set of predetermined features are present. As the features consist of a predetermined value or range of values for one or more of the data fields having given meanings, this determination is performed simply by examination of the data fields. In respect of each rule, the data fields having the given meanings are examined to determine if they have the predetermined value or range of values. Specific examples are given below. The analyser 23 produces the representation 24 of the file 100 indicating if each of the features are present.

In this embodiment, each feature has an associated label and the representation 24 is a list of the labels of features whose presence is identified. However, the representation 24 could be in any suitable forms, for example a vector having a value indicating the presence or absence of each feature in the set. Some features may be simply indicated to be present or not, for example indicated by a binary value in the representation 23. Other features may have associated therewith a value which varies over a range. In this case the value may be present in the representation 24.

The parsing and determination of features may be performed in the analyser 23 consecutively but are more commonly performed together by the analyser 23 determining successive data fields and then, in the case of data fields with which a feature is associated, validating the data field against the validation rule.

The representation 24 of the input file 100 is then supplied to a classifier 25 which implements a classification technique to perform the classification that the file 100 is clean or dirty. In fact the classifier 25 classifies the file 100 as belonging to one of the classes of the reference files 101 of the corpus stored in the database 41. The classification technique is performed on the basis of the parameters 13 in respect of each feature supplied from the training system and derived from the reference files. Thus the parameters 13 control the extent to which each feature or combination of features contributes to the classification.

In principle the classifier 25 may use any of a wide range of classification techniques which are known in general in the field of data mining. Thus possible classifiers 25 include, but are not limited to, linear classifiers, Bayesian filters (eg Naive Bayes), Neural Network (Multi-layer Perceptron), Support Vector Machines, k-Nearest Neighbours, Gaussian Mixture Model, Gaussian, Naive Bayes, Decision Tree and RBF classifiers, classifiers employing genetic algorithms and other evolutionary systems.

An example of in which the classifier 25 is a linear classifier will now be described. In this case, the classifier 25 calculates a linear combination of values associated with each feature. Those values are weighted in the linear combination by respective weightings in respect of each feature. In this example those weightings constitute the parameters 13 which are supplied from the training system 32. For example, the linear combination may be calculated in accordance with the equation:

$$S = {\sum }_{j} {w}_{j} {a}_{j} {x}_{j}$$

where S is the linear combination, j is the index signifying the different features, xⱼ is the value associated with the jth feature, wⱼ is the weighting associated with the jth feature, and aⱼ is the number of times that the jth feature is present in the file 100 (and may optionally be omitted). The value xⱼ associated with a feature may be a binary value (eg 0 or 1) in the case that the feature is merely present or absent, or may vary across a range (eg from 0 to 1).

The classifier 25 classifies the file 100 as a dirty file or a clean file on the basis of a comparison of the linear combination with a threshold. For example, the classifier 25 may classify the file 100 as a dirty file if the linear combination exceeds a threshold T or as a clean file otherwise. The threshold may be predetermined or may be a variable and constitute one of the parameters 13.

Various modifications to such a linear classifier as possible, for example as follows.

The above example assumes there are two classes representing clean or dirty files. In the case that there a plural classes representing dirty files, each class has its own set of weights wⱼₖ where k is the index signifying the different classes. In this case a linear combination Sₖ is calculated for each class and compared with a respective threshold Tₖ for each class. The classifier 25 may classify the file 100 as a dirty file if the linear combination Sₖ for any class exceeds the threshold Tₖ for that class or as a clean file otherwise.

The weights can take account of correlations between features by using a matrix calculation in which the weights are represented by a matrix W in which the diagonal elements correspond to the weights wⱼ associated with each feature and the other elements correspond to the correlations between the features.

Similarly functions of the values xⱼ associated with each feature other than a linear combination may be applied.

The classifier 25 stores data representing the classification of the file 100. The classification may also be output, for example by being displayed. Thereafter the classification subsystem 12 makes a determination in step 26 of whether the file 100 is classified as being a clean file or a dirty file.

Responsive to the file 100 being classified as a clean file, in step 27 the scanning system 1 allows the message 2 to be passed on through the network.

Responsive to the file 100 being classified as a dirty file, a remedial action unit 28 is operates to take a remedial action in respect of the file 100. A wide range remedial actions are possible. Some examples are: quarantining the file 100; subjecting the file 100 to further tests; scheduling the file 100 for examination by a researcher; scheduling the file 100 for further automatic checks; blocking the file 100 or the message 2 from passing further through the network; deleting the file 100 from the message 2; informing various parties of the event either immediately, or on various schedules. Any one or combination of remedial actions may be performed. The remedial action may be dependent on the requirements of the sender/recipient/administrator. If the scanning system 1 is part of a larger scanner then the remedial action may also be dependent on the results of other types of scan.

The training subsystem 32 will now be described.

The training subsystem 32 comprises a file format identifier 41 and an analyser section 42 comprising plural analysers 43 which together extract a representation 44 of each reference file 101 in the corpus stored in the database. The file format identifier 41, analyser section 42 and plural analysers 43 of the training subsystem 32 are identical to the file format identifier 21, analyser section 22 and plural analysers 23 of the classification subsystem 12. Thus they extract representation 44 of each reference file 101 in the same feature space as used by the classifier 25 of the classification subsystem 12.

The representation 44 of each reference file 101 and the class of each reference file 101 are supplied to a trainer 45 which uses this data to derive the parameters 13 from the representations 44 of each reference file 101 in the feature space. The training technique used by the trainer 45 corresponds to the classification technique so that the parameters 13 may be used by the classifier 25 of the classification subsystem 12. Once derived, the parameters 13 are stored in the training system 30 and supplied to the classification system 10, for example by the training system 30 outputting a signal indicating the parameters 13.

For example in the example that the classifier 25 is a linear classify as described above, the trainer 45 may employ the following linear training technique. In this case, the trainer 45 solves a set of linear inequations (equations representing ineqalities) to derive the weights wⱼ associated with each feature. For example i linear inequations may be expressed:

$${( - 1 )}^{{k}_{i}} {\sum }_{j} {w}_{j} {a}_{ij} {x}_{j} > {( - 1 )}^{{k}_{i}} {T}_{i}$$

where i is the index signifying the different references files 101, j is the index signifying the different features, xⱼ is the value associated with the jth feature, wⱼ is the weighting associated with the jth feature, aᵢⱼ is the number of times that the jth feature is present in the ith reference file 101 (and may optionally be omitted), Tᵢ is a threshold for the ith reference file, kᵢ represents the class of the ith file by being 0 if the file is clean or 1 if the file is dirty. As previously, the value xⱼ associated with a feature may be a binary value (eg 0 or 1) in the case that the feature is merely present or absent, or may vary across a range (eg from 0 to 1).

The inequations are solved allowing the weightings wⱼ to vary between values of MaxScore and (−MaxScore). This may be tackled using standard techniques, for example iterative techniques. The thresholds Tᵢ may be initially set to predetermined value, eg (MaxScore/2), but can be changed by trainer 25 to find the best solution for the inequations. As a result of this process, the weightings wⱼ for the respective features will be obtained.

It can be seen from the above description of the classifier 25 as a linear classifier that the weights wⱼ associated with each feature contained in the parameters 13 effectively indicate the significance of the feature. A higher weight increases the linear combination and so means that the feature is more likely to signify a dirty file. A negative weight decreases the linear combination and so means that the feature is more likely to signify a clean file. With other types of classification technique, the parameters similarly indicate the significance of the different features.

Thus the parameters 13 may be considered as a type of signature for identifying malware in files. The scanning system 1 is nonetheless heuristic in the sense that it only indicates a probabilistic likelihood of the file 100 being dirty or clean on the basis of similarity with the reference files 101, rather than identifying an actual piece of malware in the manner of a true signature. However the scanning system combines advantages of both worlds, that is combining heuristic analysis capable of finding new malware with the ease of maintaining signatures, also automating the process to significant extent. Thus the parameters 13 may be considered as a heuristic signature.

Such classification allows detection of new pieces of malware when first encountered and before there has been time to develop a signature. This is because the classification is based on the reference files 101 and therefore allows detection of malware on the basis of similarity with the reference files 101. Otherwise, only much later in time might malware researchers actually recognise the piece of malware and develop a signature. Accordingly the scanning system 1 provides protection in the intervening period.

Ultimately the effectiveness of the scanning system 1 is dependent on the scope and variety of the reference files 101 in the corpus but with a good corpus the automated nature of the training allows the following advantages to be obtained:
1) quick response to new threats;
2) proactive identification of new threats with reduced human involvement;
3) a reduction in the number of highly trained professionals needed to maintain the detection rates for new malware;
4) a reduction in the number of False Positives;
5) a reduction in the amount of time needed to be spent on ensuring low False Positive rates; and/or
6) a reduction in the costs associated with running the antivirus lab in any AV company.

The nature of the features will now be considered in detail.

As previously mentioned, the features consist of a predetermined value or range of values for one or more of the data fields having given meanings. This means that the features effectively make sense of and interpret features of the file 100 which are meaningful in the context of detecting malware because they relate to the function of the file 100. This is because of the nature of the data fields. As the data fields have a meaning which allows the file to be properly interpreted, use of features based on data fields having particular meanings allows for effective discrimination between dirty files containing malware and clean files, because the features are meaningful to the functionality of the file 100. Thus the features provide for more powerful classification than merely using, for example, the underlying raw data of the file 100 or mere extracted strings.

The features are specific to each file format and in general a wide range of features may be selected. This will include features which may be suspicious from the point of view of the file 100 containing malware, for example features which are invalid for the file format concerned. However, importantly the features should also include features which are not necessarily suspicious including features which are valid for the file format concerned. This results from the automatic training of the classifier 25 performed by the trainer 45. This means that the developer does not need to know how useful a feature will be for forming any opinion about the file now or in the future, because the actual significance of the features is determined by the trainer 45. If a given feature is not in fact significant, the trainer 45 will simply derive parameters that take account of this, for example deriving a low weighting wⱼ in the example above.

This contrasts with the development of a traditional heuristic analysis technique in which a specialist needs to decide what aspects of a file are significant. This is dependent on the skill of the specialist concerned and the heuristics may not be ideal. However, in the present invention, the developer should simply select all features which might be relevant as the trainer 45 will automatically derive the actual relevance. This should include features which are not unambiguously indicative of malware. In other words the operation of the scanning system 1 allows the developer to concentrate on the development of the feature extraction performed by the analysers 23 and 43 without needing to assess the actual significance of the features.

Thus the features should cover as wide a range of types as possible. This means that the features should include, if possible, features relating to data fields having plural different meanings.

Features can be related to combinations of plural data fields, or can include composite features which are combinations of other features (eg the presence of Feature A and Feature B in combination constitute Feature C).

Some examples of suitable features are as follows.

In many but not all file formats, the file format includes a file header followed by a number of data blocks described in that header. Data blocks might each contain its own block header. The headers and data blocks may consist of one or plural data fields. Data blocks may have data fields representing tags associated with them, for example being present in a field of a header. Data tags may indicate what a data block is for. Headers may contain data fields representing file size information about the size of the file and/or data fields representing pointers to data blocks. In file formats including these types of features, the features may relate to:
1. the data fields of the file headers and/or data blocks and/or block headers;
2. the content of the tag, eg that the tag of a data block is in a given range, or in the case that the tag describes the colour of a pixel, the colour is in a given range, etc.;
3. the destination of pointers, eg as to whether they point to a range within the file or data block; and/or
4. the file size information being in a given range with respect to the actual size of the file, for example being equal to the actual size or being less than the actual size.

However these examples are by no means limitative. Some file formats include similar features but perhaps called different names in the specification of the standard. Depending on the file format, concerned other features of the structure and content of the data fields may be used.

As to the derivation of the features, initially they would be based on publically available information. Many file formats have a published specification which can be used to derive the features. Even if there is no formal specification, there is typically information of the format available, particularly on the internet. For example, the website http://www.wotsit.org contains a description of many file formats. Additional information is available intrinsically from the files and may be obtained by reverse-engineering.

In the case of a file format for an executable file, the features may relate to predetermined values or ranges of values for the following data fields:

a) Compile Date

b) Entry Point

b) a hash value (eg an MD5 hash value) of each exe section in the file

c) number of sections—number of sections is a value from the header part of a Portable Executable file format. It indicates how many logical structures called “sections” are present there. This number together with information about sections themselves is used by Windows loader when deciding how to allocate memory for an executable file and, therefore, may be involved together with other information from the EXE file in either exploiting some lesser known vulnerabilities of Windows loader, or can be used in such a way as to exploit differences between how Windows loader works and how AntiVirus engine attempts to emulate Windows loader, thus enabling malware to detect AntiVirus engine and prevent it from detecting malware in it.

d) the size of the file

e) the entry point, eg whether the Entry Point points to the file header

f) combinations of any of the above (i.e., Compile Date and Entry Point concatenated)

g) data fields indicating if there is more than 1 import

h) data fields indicating if file has a mail engine in it

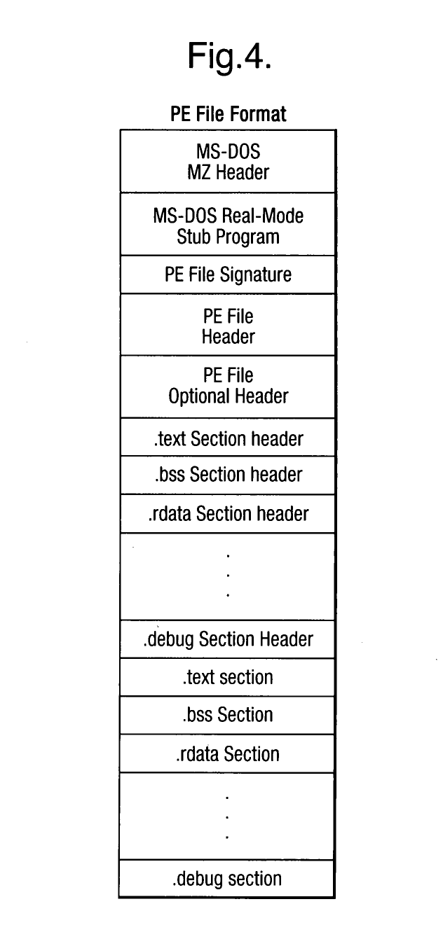

Further examples will now be given with respect to the Portable Executable (PE) file format. This has a high-level structure of blocks as shown in FIG. 4. Each high-level bock has its own internal structure, best described by C structures. A C structure is nothing more complicated than a list of data types and comprehensible human-readable names in exactly the same order as they appear in the physical file. For example, “PE File Optional Header” is described by the following C structure:

```
typedef struct_IMAGE_OPTIONAL_HEADER {
    WORD Magic;
    BYTE MajorLinkerVersion;
    BYTE MinorLinkerVersion;
    DWORD SizeOfCode;
    DWORD SizeOfInitializedData;
    DWORD SizeOfUninitializedData;
    DWORD AddressOfEntryPoint;
    DWORD BaseOfCode;
    DWORD BaseOfData;
    DWORD ImageBase;
    DWORD SectionAlignment;
    DWORD FileAlignment;
    WORD MajorOperatingSystemVersion;
    WORD MinorOperatingSystemVersion;
    WORD MajorImageVersion;
    WORD MinorImageVersion;
    WORD MajorSubsystemVersion;
    WORD MinorSubsystemVersion;
    DWORD Win32VersionValue;
    DWORD SizeOfImage;
    DWORD SizeOfHeaders;
    DWORD CheckSum;
    WORD Subsystem;
    WORD DllCharacteristics;
    DWORD SizeOfStackReserve;
    DWORD SizeOfStackCommit;
    DWORD SizeOfHeapReserve;
    DWORD SizeOfHeapCommit;
    DWORD LoaderFlags;
    DWORD NumberOfRvaAndSizes;
    IMAGE_DATA_DIRECTORY
DataDirectory[IMAGE_NUMBEROF_DIRECTORY_ENTRIES];
} IMAGE_OPTIONAL_HEADER32,
*PIMAGE_OPTIONAL_HEADER32;
    The “PE File Header” is described using this structure:
typedef struct_IMAGE_FILE_HEADER {
    WORD Machine;
    WORD NumberOfSections;
    DWORD TimeDateStamp;
    DWORD PointerToSymbolTable;
    DWORD NumberOfSymbols;
    WORD SizeOfOptionalHeader;
    WORD Characteristics;
} IMAGE_FILE_HEADER, *PIMAGE_FILE_HEADER;
    Any Section Header has the following structure:
#define IMAGE_SIZEOF_SHORT_NAME  8
typedef struct_IMAGE_SECTION_HEADER {
    BYTE Name[IMAGE_SIZEOF_SHORT_NAME];
    union {
        DWORD PhysicalAddress;
        DWORD VirtualSize;
    } Misc;
    DWORD VirtualAddress;
    DWORD SizeOfRawData;
    DWORD PointerToRawData;
    DWORD PointerToRelocations;
    DWORD PointerToLinenumbers;
    WORD NumberOfRelocations;
    WORD NumberOfLinenumbers;
    DWORD Characteristics;
} IMAGE_SECTION_HEADER, *PIMAGE_SECTION_HEADER;
```

The analyser 23 or 43 for PE file format would analyse the file 100 or 101 would operate as follows to extract features. For brevity, this is merely part of the operation for illustrative purposes.
1) Analyser 23 or 43 opens a file.
2) Analyser 23 or 43 reads MZ header, where it would find “PE File Signature” offset.
3) If that offset is pointing outside of file, analyser 23 or 43 extracts a feature, which is a textual tag only—“PE_HEADER_OUT_OF_FILE”; if that offset is 0, analyser 23 or 43 extracts a different feature: “ZERO_PE_HEADER_OFFSET”.
4) Analyser 23 or 43 moves to the determined offset and checks for “PE File Signature”, which should be 4 bytes equivalent to “PE\0\0”. If there is no such sequence of bytes, analyser 23 or 43 extracts a new feature: “NO_PE_HEADER_AT_OFFSET: 0x00000080”, where the real value of offset is the one read from the file during step 2; this feature contains data associated with it.
5) Analyser 23 or 43 then moves to “PE File Header”, where, amongst other things, it finds NumberOfSections field. As soon as it sees it, it extracts a feature: “PE_NUMBER_OF_SECTIONS:2”, where the value is the actual number of sections. At the same time, it attempts to check whether NumberOfSections is actually a reasonable number—i.e., it is a positive integer, which is less than some predefined value—say, 256; the value would be determined from analysing statistical data in the central database; if the number of sections is higher than that, analyser 23 or 43 extracts another feature: “HUGE_NUMBER_OF_SECTIONS”.
6) Analyser 23 or 43 then moves to “PE File Optional Header”, where amongst others, it extracts AddressOfEntryPoint as a feature; for example:
“PE_ENTRY_POINT_ADDRESS: 0x0005975E”. At the same time, it compares this address (which is a pointer within the file) with the size of the file and, if out of file, extracts another feature “PE_ENTRY_POINT_OUT_OF_FILE”. If the entry point does not point to a section, a new feature is extracted.
“PE_ENTRY_POINT_NOT_IN_SECTION”. If the entry point points to non-executable section (which is a flag of a section), a new feature is extracted.
“PE_ENTRY_POINT_NOT_IN_EXEC_SECTION”. If the entry point points to, say, “MS-DOS MZ Header”, then a new feature is extracted.
“PE_ENTRY_POINT_IN_DOS_HEADER”. It is possible that there is a gap between “PE Optional Header” and “.text Section Header”. If the entry point points to that gap, then a new feature is extracted.
“PE_ENTRY_POINT_IN_SECTION_GAP”. The list of features to extract and what comparisons to make to extract those features that are not directly associated with data, is determined by a human and is fed into a analyser 23 or 43 as either an in-built knowledge, or external data file. What is important is that at Analyser 23 or 43 stage no scoring of items occurs and no decisions about how malicious the file is are made.
7) It is estimated that by the end of processing of “PE File Optional Header”, around 30-50 features will be extracted.
8) The first “Section Header” is now processed (“.text Section Header”). Name field (see above structure) is checked whether it is all ASCII characters. If not, a new feature is extracted “PE_SECTION_NAME_IS_NOT_ASCII”. VirtualSize is checked to compare it with the file size. If it is larger, a new feature is extracted “PE_HUGE_SECTION_SIZE”. If VirtualAddress is 0, another feature is extracted “PE_SECTION_OVERWRITES_PE_IMAGE”. If SizeOfRawData is 0 or larger than the file size or the sum of all SizeOfRawData for all sections is larger than a file, then corresponding features are extracted. If PointerToRawData points outside of a file, then relevant features are extracted. If two sections have the same PointerToRawData, then “PE_TWO_IDENTICAL_SECTIONS” feature is extracted. Etc, etc, etc—the possibilities are endless.
9) PointerToRawData and SizeOfRawData are used to identify the section boundaries within the file and calculate its hash (MD5 or SHA-256 or any other) and extract a new feature: “PE_SECTION_MD5:1: d94e9642392e65c69b3f874ef707b2a3”
10) The process goes on for other parts of the file.

An extremely similar process is used for any structured file format.

1. A scanning system for scanning computer files for malware, the scanning system comprising:
a classification system comprising:
a file format identifier arranged to determine the file format of an input file as being one of a plurality of predetermined file formats in accordance with which files comprise data fields having a predetermined structure and predetermined meanings,
an analyser section arranged to determine a representation of the input file in a feature space defined by a set of predetermined features for each file format, the features being a predetermined value or range of values for one or more data fields of given meanings, the analyser section being operative to parse the input file on the basis of the structure of data fields in the determined file format to identify the data fields of the input file and their meaning and to determine, on the basis of the identified data fields, which of the set of predetermined features are present in the input file as said representation, and
a classifier arranged to classify the input file, on the basis of the determined representation of the input file in said feature space, as being a clean file free of malware or a dirty file containing malware using parameters associated with said set of predetermined features; and
a training system comprising:
a database containing a corpus of reference files including clean files known to be free of malware and dirty files known to contain malware,
a file format identifier arranged to determine the file format of respective reference files as being one of said plurality of predetermined file formats used by the file format identifier of the classification system,
an analyser section arranged to determine representations of the respective reference files in said feature space used by the analyser section of the classification system, the analyser section being operative to parse the respective reference files on the basis of the structure of data fields in the determined file format to identify the data fields of the input file and their meaning and to determine, on the basis of the identified data fields, which of the set of predetermined features are present in the respective reference files file as the respective representations, and
a trainer arranged to derive said parameters used by said classifier of said classification system from the corpus of reference files on the basis of the determined representations of the reference files in said feature space.

2. A scanning system according to claim 1, wherein the classifier is a linear classifier.

3. A scanning system according to claim 1, wherein said parameters comprise respective weightings for each feature and said classifier is arranged to classify the input file by calculating a function of a value associated with each feature and the respective weightings, the input file being classified as being a clean file or a dirty file on the basis of a comparison of the linear combination with a predetermined threshold.

4. A scanning system according to claim 3, wherein said function is a linear combination of a value associated with each feature weighted by the respective weightings.

5. A scanning system according to claim 1, wherein the predetermined file formats include at least one file format for an executable file and the features include one or more features selected from:
a predetermined value or range of values for the compile date;
a predetermined value or range of values for the entry point;
a predetermined value or range of values for a hash file of one or more exe section;
a predetermined value or range of values for number of sections;
a predetermined value or range of values for the size of the file;
a predetermined value or range of values for that the entry point; or
any combination thereof.

6. A scanning system according to claim 5, wherein the predetermined file formats include the Portable Executable format.

7. A scanning system according to claim 1, wherein the features include features which specify invalid structure and/or content for the data fields of the determined file format and features which specify valid structure and/or content for the data fields of the determined file format.

8. A scanning system according to claim 1, wherein the features are a predetermined value or range of values for one or more data fields of at least two different meanings.

9. A scanning system according to claim 1, wherein the classifier of the classification system is operative to store data indicating the determination and/or to output a signal indicating the determination.

10. A scanning system according to claim 1, the classification system further comprising a remedial action unit which is operative, responsive to the classifier classifying an input file as being a dirty file, to perform a remedial action in respect of that file.

11. A scanning system according to claim 1, wherein the files include any one or both of files capable of being rendered by an application program and files capable of being processed by an operating system.

12. A scanning system according to claim 1, wherein the files are being transferred through a node of a network.

13. A scanning system according to claim 1, wherein the files are contained in any one or more of emails, HTTP traffic, FTP traffic, and IM traffic, SMS traffic or MMS traffic.

14. A classification system for scanning computer files for malware, the classification system comprising:
a file format identifier arranged to determine the file format of an input file as being one of a plurality of predetermined file formats in accordance with which files comprise data fields having a predetermined structure and predetermined meanings,
an analyser section arranged to determine a representation of the input file in a feature space defined by a set of predetermined features for each file format, the features being a predetermined value or range of values for one or more data fields of given meanings, the analyser section being operative to parse the input file on the basis of the structure of data fields in the determined file format to identify the data fields of the input file and their meaning and to determine, on the basis of the identified data fields, which of the set of predetermined features are present in the input file as said representation, and
a classifier arranged to classify the input file, on the basis of the determined representation of the input file in said feature space, as being a clean file free of malware or a dirty file containing malware using parameters associated with said set of predetermined features.

15. A training system for deriving parameters for a classification system for scanning computer files for malware, the training system comprising:
a database containing a corpus of reference files including clean files known to be free of malware and dirty files known to contain malware,
a file format identifier arranged to determine the file formats of respective reference files as being one of a plurality of predetermined file formats in accordance with which files comprise data fields having a predetermined structure and predetermined meanings,
an analyser section arranged to determine representations of the respective reference files in a feature space defined by a set of predetermined features for each file format, the features being a predetermined value or range of values for one or more data fields of given meanings, the analyser section being operative to parse the respective reference files on the basis of the structure of data fields in the determined file format to identify the data fields of the input file and their meaning and to determine, on the basis of the identified data fields, which of the set of predetermined features are present in the respective reference files file as the respective representations, and
a trainer arranged to derive, from the corpus of reference files on the basis of the determined representations of the reference files in said feature space, parameters for use by a classifier to classify an input file, on the basis of a representation of the input file in said feature space, as being a clean file free of malware or a dirty file containing malware.

16. A method of scanning computer files for malware, the method comprising:
a classification process comprising:
determining the file format of an input file as being one of a plurality of predetermined file formats in accordance with which files comprise data fields having a predetermined structure and predetermined meanings,
determining a representation of the input file in a feature space defined by a set of predetermined features for each file format, the features being a predetermined value or range of values for one or more data fields of given meanings, by parsing the input file on the basis of the structure of data fields in the determined file format to identify the data fields of the input file and their meaning and determining, on the basis of the identified data fields, which of the set of predetermined features are present in the input file as said representation, and
classifying the input file, on the basis of the determined representation of the input file in said feature space, as being a clean file free of malware or a dirty file containing malware using parameters associated with said set of predetermined features; and
a training process comprising:
maintaining a database containing a corpus of reference files including clean files known to be free of malware and dirty files known to contain malware,
determining the file formats of respective reference files as being one of said plurality of predetermined file formats,
determining representations of the respective reference files in said feature space by parsing the respective reference files on the basis of the structure of data fields in the determined file format to identify the data fields of the input file and their meaning, and determining, on the basis of the identified data fields, which of the set of predetermined features are present in the respective reference files as the respective representations, and
deriving said parameters used in said classifying step of said classification process from the corpus of reference files on the basis of the determined representations of the reference files in said feature space.

17. A method according to claim 16, wherein the classifying step of the classification process uses linear classification.

18. A method according to claim 16, wherein said parameters comprise respective weightings for each feature and the classifying step of the classification process comprises calculating a function of a value associated with each feature and the respective weightings and classifying the input file as being a clean file or a dirty file on the basis of a comparison of the linear combination with a predetermined threshold.

19. A method according to claim 18, wherein said function is a linear combination of a value associated with each feature weighted by the respective weightings.

20. A method according to claim 16, wherein the predetermined file formats include at least one file format for an executable file and the features include one or more features selected from:
a predetermined value or range of values for the compile date;
a predetermined value or range of values for the entry point;
a predetermined value or range of values for a hash file of one or more exe section;
a predetermined value or range of values for number of sections;
a predetermined value or range of values for the size of the file;
a predetermined value or range of values for that the entry point; or any combination thereof.

21. A method according to claim 20, wherein the predetermined file formats include the Portable Executable format.

22. A method according to claim 16, wherein the features include features which specify invalid structure and/or content for the data fields of the determined file format and features which specify valid structure and/or content for the data fields of the determined file format.

23. A method according to claim 16, wherein the features are a predetermined value or range of values for one or more data fields of at least two different meanings.

24. A method according to claim 16, further comprising storing data representing said determination and/or outputting a signal indicating said determination.

25. A method according to claim 16, the classification process further comprising, responsive to an input file being classified as a dirty file, performing a remedial action in respect of that input file.

26. A method according to claim 16, wherein the files include any one or both of files capable of being rendered by an application program and files capable of being processed by an operating system.

27. A method according to claim 16, wherein the files are being transferred through a node of a network.

28. A method according to claim 16, wherein the files are contained in any one or more of emails, HTTP traffic, FTP traffic, IM traffic, SMS traffic or MMS traffic.

29. A method of scanning computer files for malware, the method comprising:
determining the file format of an input file as being one of a plurality of predetermined file formats in accordance with which files comprise data fields having a predetermined structure and predetermined meanings,
determining a representation of the input file in a feature space defined by a set of predetermined features for each file format, the features being a predetermined value or range of values for one or more data fields of given meanings, by parsing the input file on the basis of the structure of data fields in the determined file format to identify the data fields of the input file and their meaning and determining, on the basis of the identified data fields, which of the set of predetermined features are present in the input file as said representation, and
classifying the input file, on the basis of the determined representation of the input file in said feature space, as being a clean file free of malware or a dirty file containing malware using parameters associated with said set of predetermined features.

30. A method of deriving parameters for classification of computer files, the method comprising:
maintaining a database containing a corpus of reference files including clean files known to be free of malware and dirty files known to contain malware,
determining the file formats of respective reference files as being one of a plurality of predetermined file formats in accordance with which files comprise data fields having a predetermined structure and predetermined meanings,
determining representations of the respective reference files in a feature space defined by a set of predetermined features for each file format, the features being a predetermined value or range of values for one or more data fields of given meanings, by parsing the respective reference files on the basis of the structure of data fields in the determined file format to identify the data fields of the input file and their meaning and determining, on the basis of the identified data fields, which of the set of predetermined features are present in the respective reference files file as the respective representations, and
deriving, from the corpus of reference files on the basis of the determined representations of the reference files in said feature space, parameters for use in classifying an input file, on the basis of a representation of the input file in said feature space, as being a clean file free of malware or a dirty file containing malware.

31. A method according to claim 30, further comprising storing data representing said parameters and/or outputting a signal indicating said parameters.
